(19) United States
(12) Patent Application Publication
(10) Pub. No.: US 2020/0247303 A1
(43) Pub. Date: Aug. 6, 2020

(54) DELIVERY SYSTEM AND DELIVERY METHOD

(71) Applicant: TOYOTA JIDOSHA KABUSHIKI KAISHA, Toyota-shi (JP)

(72) Inventors: Zekai QIU, Nisshin-shi (JP); Akie SAKIYAMA, Toyota-shi (JP); Yusuke TAKEUCHI, Miyoshi-shi (JP); Jun HIOKI, Nagakute-shi (JP); Shinji SASSA, Ama-shi (JP); Hiromitsu FUJII, Kariya-shi (JP); Keita TERUUCHI, Toyota-shi (JP)

(73) Assignee: TOYOTA JIDOSHA KABUSHIKI KAISHA, Toyota-shi (JP)

(21) Appl. No.: 16/783,317

(22) Filed: Feb. 6, 2020

(30) Foreign Application Priority Data
Feb. 6, 2019 (JP) 2019-020128

(51) Int. Cl. B60P 3/20; G06Q 10/08; G06Q 10/10; G05D 1/00; G05D 1/02; G05D 23/00

(52) U.S. Cl. CPC B60P 3/20; G06Q 10/0832; G05D 23/00; G05D 1/0088; G05D 1/0246; G06Q 10/1097

(57) ABSTRACT

A delivery system includes a vehicle including a storage compartment where a temperature can be changed within a predetermined temperature range, the vehicle being configured to deliver an item stored in the storage compartment to a delivery destination, and a processor configured to acquire a relationship between a current time and a scheduled arrival time of the item at the delivery destination, and control a temperature of the storage compartment corresponding to the relationship between the current time and the scheduled arrival time of the item at the delivery destination, such that the item reaches a state of a second temperature at a time of handing-over from a state of a first temperature at a time of delivery request.

### CROSS REFERENCE TO RELATED APPLICATION

This application claims the benefit of Japanese Patent Application No. 2019-020128, filed on Feb. 6, 2019, which is hereby incorporated by reference herein in its entirety.

### BACKGROUND

### Technical Field

The present disclosure relates to a delivery system and a delivery method.

### Description of the Related Art

Delivering a package to a delivery box at a delivery destination by an autonomous vehicle is proposed (for example, Patent document 1). In a case where a package is food, delivery may be performed in a refrigerated state or a frozen state.

### CITATION LIST

### Patent Document

Patent document 1: Japanese Patent Laid-Open No. 2018-177439

An object of an aspect of the disclosure is to provide a delivery system and a delivery method enabling an item to be handed over while at an appropriate temperature.

### SUMMARY

An aspect of the present disclosure is a delivery system including:

a vehicle that includes a storage compartment where a temperature can be changed within a predetermined temperature range, the vehicle being configured to deliver an item stored in the storage compartment to a delivery destination; and a processor configured to:
acquire a relationship between a current time and a scheduled arrival time of the item at the delivery destination, and control a temperature of the storage compartment corresponding to the relationship between the current time and the scheduled arrival time of the item at the delivery destination, such that the item reaches a state of a second temperature at a time of handing-over from a state of a first temperature at a time of delivery request.

Another aspect of the present disclosure is a delivery system including:

a vehicle that includes a plurality of storage areas with different temperatures and a moving device that moves an item between the storage areas, the vehicle being configured to deliver the item to a delivery destination; and a processor configured to:
acquire a relationship between a current time and a scheduled arrival time of the item at the delivery destination, and determine a storage area where the item is to be placed, corresponding to the relationship between the current time and the scheduled arrival time of the item at the delivery destination, such that the item reaches a state of a second temperature at a time of handing-over from a state of a first temperature at a time of delivery request.

Another aspect of the present disclosure is a delivery method including:

acquiring a relationship between a current time and a scheduled arrival time at a delivery destination of an item that is delivered to the delivery destination by a vehicle including a storage compartment where a temperature can be changed within a predetermined temperature range, wherein the item is delivered being stored in the storage compartment; and controlling a temperature of the storage compartment according to the relationship between the current time and the scheduled arrival time of the item at the delivery destination, such that the item reaches a state of a second temperature at a time of handing-over from a state of a first temperature at a time of delivery request.

Another aspect of the present disclosure is a delivery method including:

acquiring a relationship between a current time and a scheduled arrival time at a delivery destination of an item that is delivered to the delivery destination by a vehicle including a plurality of storage areas with different temperatures, and a moving device that moves the item between the storage areas; and determining a storage area where the item is to be placed, corresponding to the relationship between the current time and the scheduled arrival time of the item at the delivery destination, such that the item reaches a state of a second temperature at a time of handing-over from a state of a first temperature at a time of delivery request.

According to the delivery system and the delivery method of the disclosure, an item may be handed over while at an appropriate temperature.

### BRIEF DESCRIPTION OF DRAWINGS

FIG. 1 is a diagram illustrating an example of a system configuration of a temperature-managed delivery system according to a first embodiment;

FIG. 2 is a diagram illustrating an example of a hardware configuration of a vehicle;

FIG. 3 is a diagram illustrating an example of a hardware configuration of a center server;

FIG. 4 is a diagram illustrating an example of a functional configuration of the vehicle;

FIG. 5 is an example of a delivery information management table;

FIG. 6 is an example of a package information management table;

FIG. 7 is an example of a flowchart of a temperature control process by the vehicle; and

FIG. 8 is a diagram illustrating an example of temperature management for a vehicle according to a second embodiment.

### DESCRIPTION OF THE EMBODIMENTS

For example, a boiled crab or the like bought through home shopping is possibly delivered in a frozen state. In such a case, a product which is frozen cannot be eaten immediately after reception. In the present disclosure, food in a frozen state is defrosted inside a vehicle during delivery, and is then handed over to a recipient.

One aspect of the present disclosure is a delivery system including a vehicle including a storage compartment where a temperature can be changed within a predetermined temperature range, the vehicle being configured to deliver an item stored in the storage compartment to a delivery destination, and a processor configured to acquire a relationship between a current time and a scheduled arrival time of the item at the delivery destination, and to control a temperature of the storage compartment corresponding to the relationship between the current time and the scheduled arrival time of the item at the delivery destination, such that the item reaches a state of a second temperature at a time of handing-over from a state of a first temperature at a time of delivery request.

In one aspect of the present disclosure, in a case where a remaining time until the scheduled arrival time at the delivery destination falls below a predetermined threshold, the processor may change the temperature of the storage compartment from the first temperature to the second temperature.

The processor may be provided in the vehicle, or may be a device separate from the vehicle. The item is food, for example. A range of temperatures to which the storage compartment can be changed is, but not limited to, −10 degrees C. to 70 degrees C., for example. The state of the first temperature and the state of the second temperature are different states of temperatures. The state of the first temperature and the state of the second temperature may be any of freezing, refrigeration, room temperature, and heating, for example. The state of freezing is a state of −20 degrees C. to −10 degrees C., for example. The state of refrigeration is 0 degrees C. to 10 degrees C., for example. The state of room temperature is 20 degrees C. to 25 degrees C. in summer, and 15 degrees C. to 20 degrees C. in winter, for example.

According to one aspect of the present disclosure, an item in the state of the first temperature may be delivered to a recipient after being placed in the state of the second temperature during delivery by the vehicle. For example, in a case where the item is food, the recipient may immediately eat or cook the food. Moreover, a time taken for delivery may be efficiently used.

Another aspect of the present disclosure is a delivery system including a vehicle including a plurality of storage areas with different temperatures, and a moving device that moves an item between the storage areas, the vehicle being configured to deliver the item to a delivery destination, and a processor configured to acquire a relationship between a current time and a scheduled arrival time of the item at the delivery destination, and to determine a storage area where the item is to be placed, corresponding to the relationship between the current time and the scheduled arrival time of the item at the delivery destination, such that the item reaches a state of a second temperature at a time of handing-over from a state of a first temperature at a time of delivery request.

In one aspect of the present disclosure, in a case where a remaining time until the scheduled arrival time at the delivery destination falls below a predetermined threshold, the processor may change the storage area where the item is placed from a first storage area at the first temperature to a second storage area at the second temperature, and may instruct the moving device to move the item to the second storage area.

The processor may be provided in the vehicle, or may be a device separate from the vehicle. The item is food, for example. The state of the first temperature and the state of the second temperature are different states of temperatures. The state of the first temperature and the state of the second temperature may be any of freezing, refrigeration, room temperature, and heating, for example. The storage areas may be formed partitioned off from each other by using a wall, a curtain or a storage compartment, such that a temperature does not become uniform between the storage areas, for example. The moving device may be a conveyor belt that moves between the storage areas, a robot, or a crane including a gripping mechanism for items, for example.

According to one aspect of the present disclosure, an item in the state of the first temperature may be delivered to a recipient after being placed in the state of the second temperature during delivery by the vehicle.

An aspect of the present disclosure may be grasped in relation to a delivery method. The delivery method includes acquiring a relationship between a current time and a scheduled arrival time at a delivery destination of an item that is delivered to the delivery destination by a vehicle including a storage compartment where a temperature can be changed within a predetermined temperature range, wherein the item is delivered being stored in the storage compartment, and controlling a temperature of the storage compartment corresponding to the relationship between the current time and the scheduled arrival time of the item at the delivery destination, such that the item reaches a state of a second temperature at a time of handing-over from a state of a first temperature at a time of delivery request. Furthermore, a delivery method of another mode includes acquiring a relationship between a current time and a scheduled arrival time at a delivery destination of an item that is delivered to the delivery destination by a vehicle including a plurality of storage areas with different temperatures, and a moving device that moves the item between the storage areas, and determining a storage area where the item is to be placed, corresponding to the relationship between the current time and the scheduled arrival time of the item at the delivery destination, such that the item reaches a state of a second temperature at a time of handing-over from a state of a first temperature at a time of delivery request. A technical idea disclosed with respect to the delivery systems described above may be applied to the delivery methods to the extent that no technical conflict exists.

In the following, an embodiment of the present disclosure will be described with reference to the drawings. The configuration of the embodiment described below is an example, and the present disclosure is not limited to the configuration of the embodiment.

### First Embodiment

### System Overview

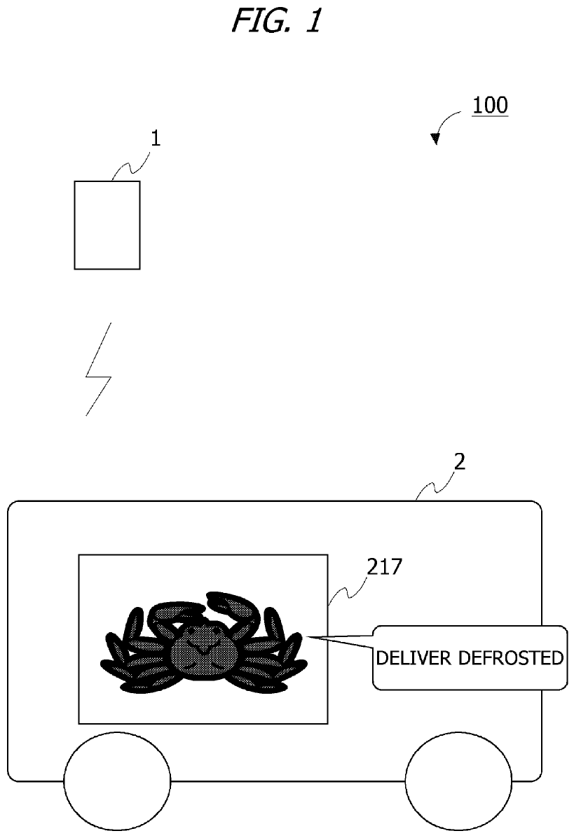

FIG. 1 is a diagram illustrating an example of a system configuration of a temperature-managed delivery system 100 according to a first embodiment. For example, the temperature-managed delivery system 100 is a system of delivering frozen food or food at a room temperature in a state where such food may be instantly eaten or cooked, by defrosting the frozen food or heating the food at a room temperature inside a delivering vehicle during delivery. Food that is placed in a defrosted state from a frozen state inside a delivering vehicle during delivery is a boiled crab, meat, a fish fillet, a cake or the like, for example. Food that is placed in a heated state from a room temperature state inside a vehicle during delivery is a bottled or canned drink that can be heated, a prepared meal or the like, for example. The temperature-managed delivery system 100 includes a center server 1 and a vehicle 2. The temperature-managed delivery system 100 is an example of a “delivery system”.

For example, the vehicle 2 is a vehicle that is capable of autonomously driving or unmanned driving. In the first embodiment, the vehicle 2 is a vehicle that delivers a package to a predetermined delivery destination. The vehicle 2 includes a storage compartment 217 where a temperature can be changed within a predetermined range, and by storing a package in the storage compartment 217, a temperature around the package may be changed during delivery, and frozen food may be delivered in a defrosted state, for example. In the first embodiment, an item that is delivered by being stored in the storage compartment 217 is assumed to be food.

For example, the vehicle 2 is connected to the Internet through a wireless communication network, and is connected to the center server 1 through the Internet. The vehicle 2 performs mobile communication according to 3rd generation (3G), Long Term Evolution (LTE), LTE-Advanced, or 5th generation (5G), or wireless communication according to wireless LAN standards such as WiFi.

The vehicle 2 creates an operation plan upon reception of an operation command from the center server 1, and performs autonomous driving to a destination according to the operation plan. The vehicle 2 includes position information acquisition means, and acquires and transmits position information to the center server 1 every predetermined period.

In the first embodiment, the vehicle 2 delivers a package by receiving a delivery request from the center server 1. In a case where there is a request to perform temperature management for defrosting or the like with respect to the package, the vehicle 2 controls a temperature of the storage compartment 217. For example, in the case where the package is frozen food, and defrosting is specified, the vehicle 2 sets the temperature of the storage compartment 217 at a temperature at which the package may be maintained in a frozen state, while a remaining time until a scheduled delivery time is longer than a time necessary for defrosting. Next, when the remaining time until the scheduled delivery time falls below the time necessary for defrosting, the vehicle 2 sets the temperature of the storage compartment 217 at a temperature at which the package reaches a defrosted state.

The temperature at which a package may be maintained in a frozen state is −18 degrees C. or lower, as in the case of a general freezer, for example. The temperature at which a package reaches a defrosted state is a temperature between 0 degrees C. and 10 degrees C., as in the case of a general refrigerator, for example. The temperature for defrosting may be set in advance according to the type of item, or a sensor may be installed in the storage compartment 217 of the vehicle 2, and the vehicle 2 may determine the temperature according to the type of package identified by an identification function of the sensor, for example.

Furthermore, for example, to allow food, which is a package, to be instantly enjoyed, the temperature of the storage compartment 217 may be set at a room temperature 30 minutes to 1 hour prior to the scheduled delivery time. For example, the room temperature is 25 degrees C. in summer, and 15 degrees C. in winter. However, such a case is not restrictive, and in the case of setting the storage compartment 217 at the room temperature, a door of the storage compartment 217 may be opened to take in outside air (air inside the vehicle 2), for example.

As described above, by controlling the temperature of the storage compartment 217 during delivery by the vehicle 2, a package may be delivered at a more appropriate temperature at which the package may be instantly eaten or cooked upon delivery, for example, and convenience regarding delivery is increased.

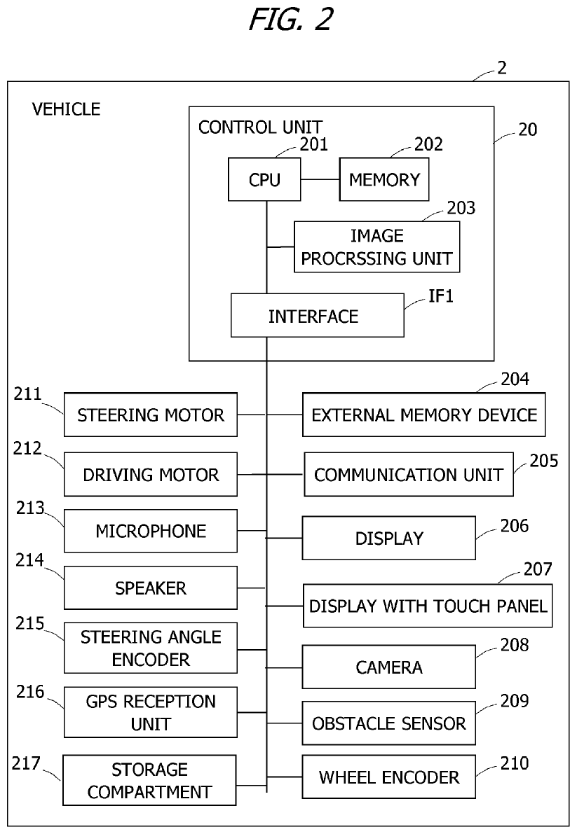

FIG. 2 is a diagram illustrating an example of a hardware configuration of the vehicle 2. In FIG. 2, the vehicle 2 is described to be a vehicle that is capable of autonomous driving. Additionally, FIG. 2 extracts and illustrates hardware related to a control system.

The vehicle 2 includes a control unit 20, an external storage device 204, a communication unit 205, a display 206, a display 207 with a touch panel, a camera 208, an obstacle sensor 209, a wheel encoder 210, a steering motor 211, a driving motor 212, a microphone 213, a speaker 214, a steering angle encoder 215, a global positioning system (GPS) reception unit 216, and the storage compartment 217.

The control unit 20 is also referred to as an electronic control unit (ECU). The control unit 20 includes a CPU 201, a memory 202, an image processing unit 203, and an interface IF1. The external storage device 204, the communication unit 205, the display 206, the display 207 with a touch panel, the camera 208, the obstacle sensor 209, the wheel encoder 210, the steering motor 211, the driving motor 212, the microphone 213, the speaker 214, the steering angle encoder 215, the GPS reception unit 216, and the storage compartment 217 are connected to the interface IF1. The control unit 20 is an example of a “processor”.

The obstacle sensor 209 is an ultrasonic sensor, a radar or the like. The obstacle sensor 209 emits an ultrasonic wave, an electromagnetic wave or the like in a detection target direction, and detects presence, a position, a relative speed or the like of an obstacle in the detection target direction on the basis of a reflected wave. The obstacle may be a pedestrian, a bicycle, a structure, a building or the like, for example. In the case where the vehicle 2 has a box-shaped body, for example, a plurality of obstacle sensors 209 are provided, and the plurality of obstacle sensors 209 are provided at positions near four corners at the front, back, left and right of the vehicle 2, respectively. Additionally, the front, back, left and right of the vehicle 2 are determined according to a traveling direction, for example.

The camera 208 is an image capturing device using an image sensor such as a charge-coupled device (CCD), a metal-oxide-semiconductor (MOS), a complementary metal-oxide-semiconductor (CMOS) or the like. The camera 208 acquires an image at a predetermined time interval called frame period, and stores the image in a frame buffer in the control unit 20. A plurality of cameras 208 are provided in the vehicle 2, and the plurality of cameras 208 are installed on respective ones of front, back, left and right side surfaces while facing outward, for example. However, such a case is not restrictive, and some cameras 208 may be installed facing the inside of the vehicle.

The steering motor 211 controls an angle of a direction of a cross line at which a plane of rotation of a wheel and a horizontal plane intersect, or in other words, a traveling direction by rotation of the wheel, according to an instruction signal from the control unit 20. The driving motor 212 drives and rotates each of four wheels provided on the vehicle 2, for example, according to an instruction signal from the control unit 20. Alternatively, the driving motor 212 may drive one pair of wheels, of two pairs of front wheels and rear wheels.

The steering angle encoder 215 detects a steering angle indicating a traveling direction of a wheel at a predetermined detection time interval, and stores the steering angle in a register of the control unit 20. The steering angle is an angle of a rotation shaft of the wheel in the horizontal plane. For example, an origin of the angle is set in a direction at which the rotation shaft of the wheel is orthogonal to the traveling direction of the vehicle 2. Furthermore, the wheel encoder 210 acquires a rotation angle of the wheel at a predetermined detection time interval, and stores the rotation angle in the register of the control unit 20.

For example, the communication unit 205 is a communication unit for communicating with various servers and the like on a network through a public communication network connected to WiFi access points or mobile phone base stations, by connecting to the WiFi access points or the mobile phone base stations. The communication unit 205 performs wireless communication by wireless signals and a wireless communication method according to a predetermined wireless communication standard.

The GPS reception unit 216 receives time signal radio waves from a plurality of global positioning satellites orbiting the Earth, and stores the time signal radio waves in the register of the control unit 20. The microphone 213 detects audio, converts the audio into a digital signal, and stores the digital signal in the register of the control unit 20. The speaker 214 is driven by a D/A converter and an amplifier connected to a signal processing unit or the control unit 20, and reproduces audio including sound and voice. The microphone 213 and the speaker 214 may each include one that is provided facing the inside of the vehicle 2 and one that is provided facing the outside of the vehicle 2.

For example, the display 206 is provided on each side surface of the body of the vehicle 2 in a manner facing the outside of the vehicle 2. The display 206 is a liquid crystal display, an electro-luminescence panel or the like, for example. The display 207 with a touch panel is an input device for an instruction from a user, and is installed facing the inside of the vehicle 2, for example. However, such a case is not restrictive, and the display 207 with a touch panel may be installed near a door of the vehicle 2 in a manner facing the outside, for example.

The CPU 201 of the control unit 20 executes a computer program that is executably developed in the memory 202, and performs a process as the control unit 20. The memory 202 stores computer programs to be executed by the CPU 201, data to be processed by the CPU 201, and the like. For example, the memory 202 is a dynamic random access memory (DRAM), a static random access memory (SRAM), a read only memory (ROM) or the like. The image processing unit 203 processes data in the frame buffer obtained from the camera 208 every predetermined frame period, in coordination with the CPU 201. For example, the image processing unit 203 includes a GPU and an image memory as the frame buffer. The external storage device 204 is a non-volatile storage, and is a solid state drive (SSD), a hard disk drive or the like, for example.

For example, the control unit 20 acquires a detection signal from a sensor of each unit of the vehicle 2, via the interface IF1. Furthermore, the control unit 20 calculates a latitude and a longitude indicating a position on the Earth, from a detection signal from the GPS reception unit 216. Moreover, the control unit 20 acquires map data from a map information database stored in the external storage device 204, checks the calculated latitude and longitude against a position on the map data, and determines a current position. Furthermore, the control unit 20 acquires a route from the current position to a destination on the map data. Moreover, the control unit 20 detects an obstacle around the vehicle 2 on the basis of a signal from the obstacle sensor 209, the camera 208 or the like, determines the traveling direction such that the obstacle is avoided, and controls the steering angle.

Furthermore, the control unit 20 processes an image acquired from the camera 208 on a per-frame data basis, in coordination with the image processing unit 203, and detects a change on the basis of a difference between images and recognizes an obstacle, for example. Additionally, the control unit 20 may transmit frame data of an image from the camera 208 and audio data obtained from the microphone 213, from the communication unit 205 to the center server 1 on the network. Then, analysis of the frame data of the image and the audio data may be assigned to the center server 1.

Still further, the control unit 20 causes images, texts, and other information pieces to be displayed on the display 206. Furthermore, the control unit 20 detects an operation on the display 207 with a touch panel, and receives an instruction from a user.

The storage compartment 217 is a heating/cooling storage where a temperature may be changed within a predetermined range. The storage compartment 217 includes a space (referred to as “inside the compartment”) for storing an item, and one or both of a cooling device or a heating device for controlling the temperature inside the compartment. For example, the storage compartment 217 controls the cooling device or the heating device according to an instruction from the control unit 20, such that a specified temperature is reached inside the compartment. The range of temperatures to which the storage compartment 217 may be changed is −20 degrees C. to 10 degrees C. (for the cooling device), or 65 degrees C. to 85 degrees C. (for the heating device), for example. A plurality of storage compartments 217 may be provided in the vehicle 2. The storage compartment 217 may include one storage area, or may include a plurality of storage areas, temperatures of which may be separately controlled, for example.

FIG. 2 illustrates the interface IF1 as an example, but exchange of signals between the control unit 20 and a control target is not limited to be performed through the interface IF1. That is, the control unit 20 may include a plurality of signal exchange paths other than the interface IF1. Furthermore, in FIG. 2, the control unit 20 includes a single CPU 201. However, the CPU is not limited to a single processor, and may adopt a multiprocessor configuration. Alternatively, a single CPU connected by a single socket may have a multicore configuration. At least a part of processes of the above-described units may be performed by a processor other than the CPU, such as a dedicated processor such as a digital signal processor (DSP) or a graphics processing unit (GPU). At least a part of processes of the above-described units may be an integrated circuit (IC) or another digital circuit. An analog circuit may be included in at least a part of the above-described units.

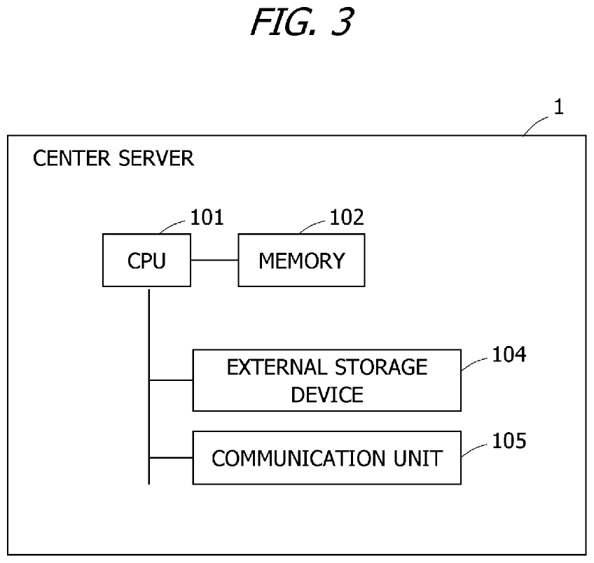

FIG. 3 is a diagram illustrating an example of a hardware configuration of the center server 1. The center server 1 includes a CPU 101, a memory 102, an external storage device 104, and a communication unit 105. Configurations and effects of the CPU 101, the memory 102, and the external storage device 104 are the same as those of the CPU 201, the memory 202, and the external storage device 204 in FIG. 2.

For example, the communication unit 105 communicates with various servers on a network, the vehicle 2 and the like through a public communication network by connecting to the public communication network through a LAN. Additionally, the hardware configuration of the center server 1 is not limited to the one illustrated in FIG. 3, and addition or substitution may be appropriately performed according to the embodiment.

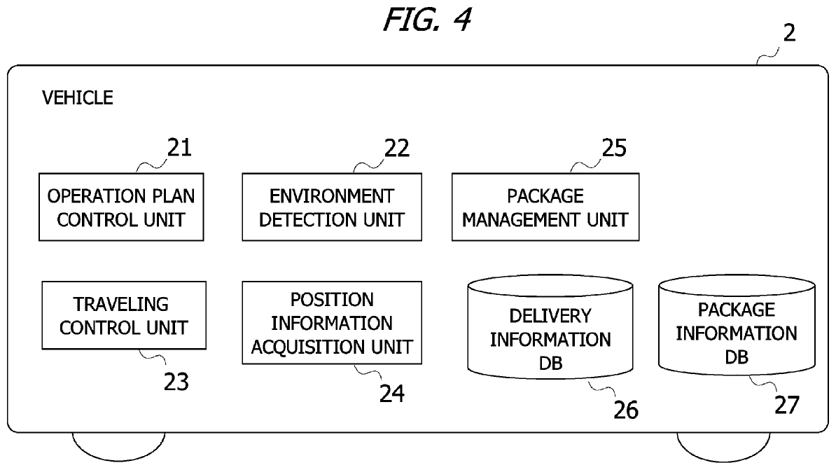

FIG. 4 is a diagram illustrating an example of a functional configuration of the vehicle 2. The vehicle 2 operates as each unit illustrated in FIG. 4 by computer programs in the memory. For example, the vehicle 2 includes, as functional structural elements, an operation plan control unit 21, an environment detection unit 22, a traveling control unit 23, a position information acquisition unit 24, a package management unit 25, a delivery information DB 26, and a package information DB 27. The operation plan control unit 21, the environment detection unit 22, the traveling control unit 23, the position information acquisition unit 24, the package management unit 25, and the package information DB 26 are functional structural elements that are implemented by execution of programs in the memory 202 by the CPU 201, for example.

For example, the position information acquisition unit 24 acquires, every predetermined period, position information of the vehicle 2 that is acquired by the GPS reception unit 216 or the like, and transmits the position information to the center server 1. The position information of the vehicle 2 is latitude and longitude, for example. Alternatively, the position information of the vehicle 2 may be an address, for example. Moreover, the position information of the vehicle 2 that is acquired by the position information acquisition unit 24 is output to the operation plan control unit 21 and the traveling control unit 23, for example.

The operation plan control unit 21 receives an operation command from the center server 1. Delivery information is also received together with the operation command. The delivery information that is received from the center server 1 includes identification information of a delivery, information about a delivery destination, information about a delivery target package, information about a scheduled delivery time, and the like, for example. The information about a delivery target package includes identification information of a package, a size of the package, information about temperature management for the package, and the like, for example. The information about temperature management for the delivery target package includes information about whether temperature management is required or not, an initial temperature, a temperature at the time of handing-over, a temperature #1, a temperature #1 estimated time and the like, for example. The temperature #1 and the temperature #1 estimated time are, in a case where the package is to be defrosted during delivery, a defrosting temperature and an estimated defrosting time, for example. In a case where the package is to be heated during delivery, the temperature #1 and the temperature #1 estimated time are a heating temperature and an estimated heating time, for example. The information about a scheduled delivery time is specified by a time slot in units of one hour or two hours, for example. The operation plan control unit 21 stores the received delivery information in the delivery information DB 26 and the package information DB 27.

In a case where there are a plurality of delivery target packages, the operation plan control unit 21 determines a delivery order on the basis of the operation command and the delivery information, for example. The delivery order is determined for each time slot, on the basis of information about the delivery destinations of packages scheduled to be delivered, for example. In a case where a delivery request is newly received, or in a case where a time that is a predetermined time before a start time of one scheduled delivery time slot is reached, for example, the operation plan control unit 21 calculates a route that runs along the delivery destinations of the packages scheduled to be delivered, and creates an operation plan.

The operation plan includes data about the route calculated in the above manner where the vehicle 2 is to travel, and data specifying processes to be performed by the vehicle 2 at a part of the route or along the entire route. An example of the process to be performed by the vehicle 2 is handing over of a package at a delivery destination. The operation plan control unit 21 outputs the created operation plan to the traveling control unit 23.

The environment detection unit 22 detects ambient environment information of the vehicle 2 to be used for autonomous driving, on the basis of data acquired by various sensors installed in the vehicle 2. Detection targets of the environment detection unit 22 are, but not limited to, the number and positions of lanes, the number and positions of vehicles that are present in the periphery of the vehicle in question, the number and positions of obstacles (such as pedestrians, bicycles, structures, buildings, etc.) that are present in the periphery of the vehicle in question, a structure of a road, a road sign and the like. The detection targets may be any objects as long as they are used to perform autonomous driving. For example, in a case where the sensor is a stereo camera, detection of an object in the periphery of the vehicle 2 is performed by subjecting image data captured by the stereo camera to image processing. Data about the ambient environment of the vehicle 2 detected by the environment detection unit 22 is output to the traveling control unit 23 described later.

For example, the traveling control unit 23 generates a control command for controlling autonomous driving of the vehicle 2, on the basis of the operation plan created by the operation plan control unit 21, data about the ambient environment of the vehicle 2 created by the environment detection unit 22, and the position information of the vehicle in question acquired by the position information acquisition unit 24. For example, when an operation plan is input from the operation plan control unit 21, the traveling control unit 23 secures safety of movement by determining whether there is an obstacle in a moving direction indicated by the operation plan. In the case where it is determined that there is no obstacle in the moving direction, the traveling control unit 23 generates a control command to cause the vehicle in question to travel along the route according to the operation plan. The created control command is transmitted to the driving motor 212. A known method may be adopted as the method for generating a control command for causing a vehicle to perform autonomous driving.

The package management unit 25 manages a delivery target package that is loaded in the vehicle 2. The package management unit 25 controls the temperature of the storage compartment 217 where the package is stored, on the basis of information stored in the package information DB 27. More specifically, the package management unit 25 changes a temperature setting for the storage compartment 217 from an initial temperature of the package to a specified temperature different from the initial temperature, on the basis of a relationship between a remaining time until a start time of a delivery time slot of the package that is stored in the storage compartment 217 and a maintaining time at the specified temperature. Details of the process by the package management unit 25 will be given later.

The delivery information DB 26 and the package information DB 27 are created in a memory area of the external storage device 204 of the vehicle 2, for example. The delivery information DB 26 and the package information DB 27 are relational databases, for example. The delivery information DB 26 stores information about a delivery. The package information DB 27 stores information about temperature management for a package.

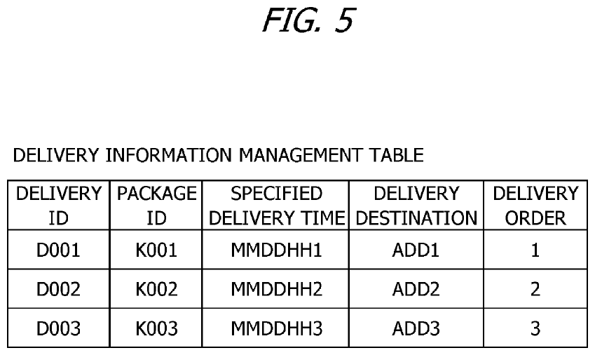

FIG. 5 is an example of a delivery information management table. The delivery information management table is stored in the delivery information DB 26. The delivery information management table illustrated in FIG. 5 includes fields of a delivery ID, a package ID, a specified delivery time, a delivery destination, and a delivery order. Identification information for identifying a delivery is stored in the field of the delivery ID. Identification information for identifying a package is stored in the field of the package ID. Information indicating a desired delivery time slot that is specified for the package is stored in the field of the specified delivery time. For example, frames of time slots for delivery are determined in advance within operating hours of delivery. For example, frames of time slots for delivery are morning (09:00 to 12:00), 14:00 to 16:00, 16:00 to 18:00, 18:00 to 20:00, 19:00 to 21:00, and the like. For example, information indicating a desired delivery time slot is a code, a flag or the like corresponding to each time slot.

The address of the delivery destination of the package is stored in the field of the delivery destination. The turn of the delivery destination of the package along the route of the vehicle 2 is stored in the field of the delivery order. Values in the fields of the delivery ID, the package ID, the specified delivery time, and the delivery destination are included in the delivery information that is received from the center server 1, for example, and are acquired from the delivery information.

Specification of a desired delivery time at the time of reception of a delivery request from a user is arbitrary, and in the case where a desired delivery time is not specified, the desired delivery time is not included in the delivery information that is received from the center server 1, or information indicating that a desired delivery time is not specified is included therein. In the case where a desired delivery time is not specified in the delivery information from the center server 1, the field of the specified delivery time is empty, for example.

The value in the field of the delivery order is updated by the operation plan control unit 21 when the delivery order is determined or changed. A determination process for the delivery order is performed by the operation plan control unit 21 with reception of new delivery information as a trigger, for example. The delivery order is determined for each time slot, for example. The delivery order in one frame of time slot is first determined for packages specifying the time slot as the desired delivery time, and is then determined by inserting a package not specifying a desired delivery time, in a case where the delivery destination of such a package is present between the delivery destinations of the packages mentioned above. However, the determination method for the delivery order of packages is not limited to such a method, and any known method may be used. Furthermore, the structure of the delivery information management table is not limited to the one illustrated in FIG. 5. Information to be stored in the delivery information DB 26 is not limited to the delivery information management table.

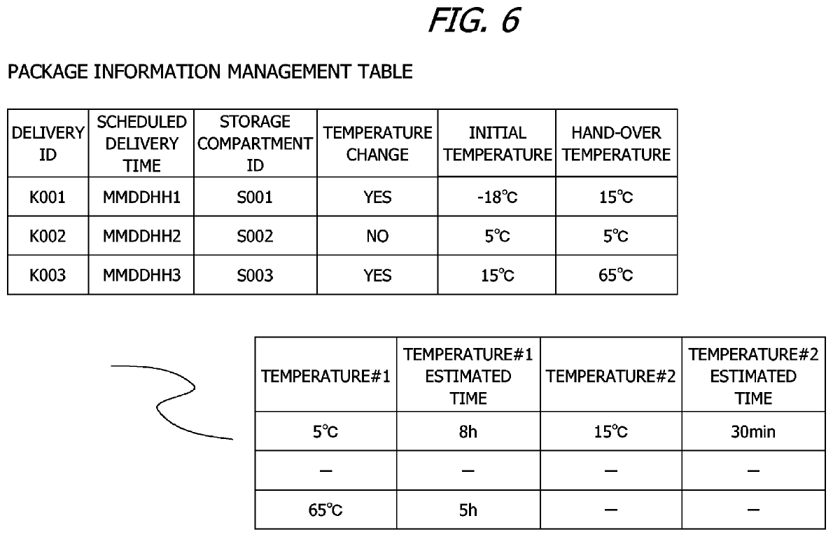

FIG. 6 is an example of a package information management table. The package information management table is stored in the package information DB 27. Information about temperature management for a package is stored in the package information management table. The package information management table illustrated in FIG. 6 includes fields of a package ID, a scheduled delivery time, a storage compartment ID, temperature change, an initial temperature, a hand-over temperature, a temperature #1, a temperature #1 estimated time, a temperature #2, and a temperature #2 estimated time.

In the field of the package ID, identification information for identifying a package is stored. In the field of the scheduled delivery time, a time slot when delivery is desired is stored, if a time slot when delivery of the package is desired is specified. In a case where a time slot when delivery of the package is desired is not specified, information indicating a scheduled delivery time slot that is determined following determination of the delivery order for the package by the operation plan control unit 21 is stored.

Identification information for identifying the storage compartment 217 where the package is stored is stored in the field of the storage compartment ID. In a case where the package is not stored in any storage compartment 217, the field of the storage compartment ID is empty.

Information indicating whether the temperature of the storage compartment 217 where the package is stored has to be changed or not is stored in the field of temperature change. The information indicating whether the temperature of the storage compartment 217 where the package is stored has to be changed or not is a flag or a code, for example. However, in the example illustrated in FIG. 6, words “YES” and “NO” are stored for the sake of convenience.

The value of an initial temperature that is set in the storage compartment 217 where the package is stored is stored in the field of the initial temperature. The value of the temperature of the package at the time of handing-over is stored in the field of the hand-over temperature. That is, the value of the temperature that is stored in the field of the hand-over temperature is a final set temperature of the storage compartment 217 with respect to delivery of one package that is stored in the storage compartment 217. The temperature that is set as the initial temperature is an example of a “first temperature”. The temperature that is set as the hand-over temperature is an example of a “second temperature”.

A set temperature for the storage compartment 217 in a first stage of temperature change, and an estimated time when the temperature is to be maintained are stored in the fields of the temperature #1 and the temperature #1 estimated time. A set temperature for the storage compartment 217 in a second stage of temperature change, and an estimated time when the temperature is to be maintained are stored in the fields of the temperature #2 and the temperature #2 estimated time.

Which package is stored in which storage compartment 217 is registered by a staff member who loads packages in the vehicle 2, through an input device provided in the vehicle 2 or through communication, for example.

Values in the fields of the package ID, the scheduled delivery time, temperature change, the initial temperature, the hand-over temperature, the temperature #1, the temperature #1 estimated time, the temperature #2, and the temperature #2 estimated time are acquired on the basis of the delivery information that is received from the center server 1, for example. However, in the case where the temperature of the storage compartment 217 does not have to be changed, the fields of the temperature #1, the temperature #1 estimated time, the temperature #2, and the temperature #2 estimated time are empty. If the temperature change includes one stage, the fields of the temperature #2 and the temperature #2 estimated time are also empty even in a case where the temperature of the storage compartment 217 has to be changed. Moreover, in the case where the temperature change includes three or more stages, fields of a temperature #3, a temperature #3 estimated time, and so on may be added.

For example, in the case of delivering frozen food by defrosting the food and placing the food at a room temperature, the value that is stored in the field of the initial temperature is −18 degrees C., at which a frozen state can be maintained. The value that is stored in the field of the hand-over temperature is 15 degrees C., which is a room temperature state. The value that is stored in the field of the temperature #1 is 5 degrees C., which is a temperature used to defrost the food. The value that is stored in the field of the temperature #1 estimated time is a time that is set for defrosting of the food. A state in which the food is frozen in such a case is an example of a “state of a first temperature”, and a state in which the food is defrosted is an example of a “state of a second temperature”.

Additionally, in the fields of the initial temperature, the hand-over temperature, the temperature #1, and the temperature #2, a code or a flag corresponding to a predetermined temperature range, such as “refrigeration”, “freezing”, “room temperature” or “heating”, may be stored instead of a specific value. For example, in the case of “refrigeration”, the storage compartment 217 is set to a temperature that is between 0 degrees C. and 10 degrees C. and that is set in advance as a temperature for “refrigeration”. For example, in the case of “freezing”, the storage compartment 217 is set to a temperature that is between −20 degrees C. and −10 degrees C. and that is set in advance as a temperature for “freezing”. For example, in the case of “room temperature”, the storage compartment 217 is set to a temperature that is between 20 degrees C. to 30 degrees C. in summer and 10 degrees C. to 20 degrees C. in winter, and that is set in advance as a temperature for “room temperature”. Alternatively, in the case of “room temperature”, a door of the storage compartment 217 may be opened so that the temperature inside the vehicle 2 and the temperature of the storage compartment 217 become the same. For example, in the case of “heating”, the storage compartment 217 is set to a temperature that is between 60 degrees C. and 70 degrees C. and that is set in advance as a temperature for “heating”.

Additionally, the structure of the package information management table is not limited to the one illustrated in FIG. 6. Furthermore, information to be stored in the package information DB 27 is not limited to the package information management table.

### Flows of Processes

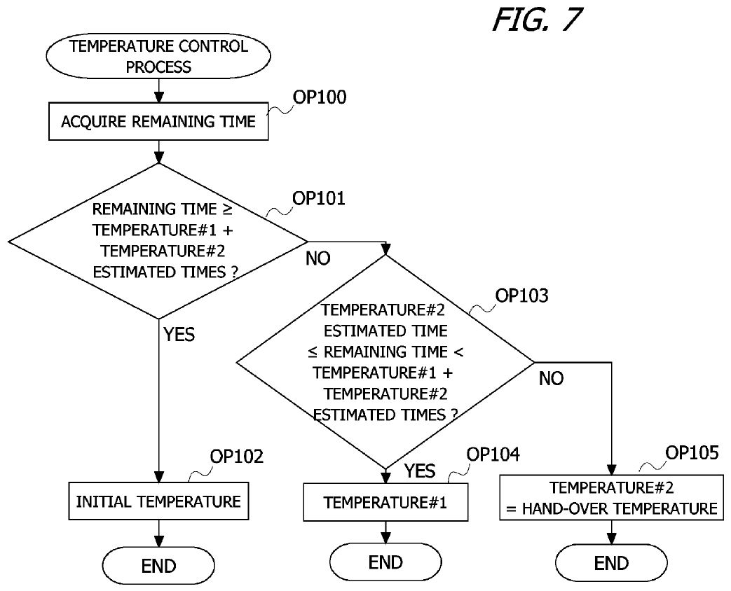

FIG. 7 is an example of a flowchart of a temperature control process by the vehicle 2. The process in FIG. 7 is performed for each one of packages that are stored in the storage compartment 217, and for which “YES” is set with respect to temperature change, for example. Furthermore, the process illustrated in FIG. 7 is repeated every predetermined period. Moreover, the process illustrated in FIG. 7 is performed by the control unit 20 of the vehicle 2, but a description will be given taking a functional structural element as a performer, for the sake of convenience. Furthermore, FIG. 7 illustrates a process for a case where the temperature #1 and the temperature #2 are set for a processing target package.

In OP100, the package management unit 25 acquires a remaining time until a start time of a scheduled delivery time slot for a processing target package.

In OP101, the package management unit 25 determines whether the remaining time until the start time of the scheduled delivery time slot for the processing target package is equal to or greater than a total value of the temperature #1 estimated time and the temperature #2 estimated time. Additionally, in the case where a temperature #3, a temperature #4 and so on are set for the processing target package, comparison is performed between the remaining time and a total value of the temperature #1 estimated time, the temperature #2 estimated time, a temperature #3 estimated time, a temperature #4 estimated time and so on. In the case where only the temperature #1 is set, comparison is performed between the remaining time and the temperature #1 estimated time.

In the case where the remaining time until the start time of the scheduled delivery time slot for the processing target package is equal to or greater than the total value of the temperature #1 estimated time and the temperature #2 estimated time (OP101: YES), the process proceeds to OP102. In the case where the remaining time until the start time of the scheduled delivery time slot for the processing target package is less than the total value of the temperature #1 estimated time and the temperature #2 estimated time (OP101: NO), the process proceeds to OP103.

In OP102, the package management unit 25 determines a set temperature of the storage compartment 217 storing the processing target package to be at the initial temperature. In the case where the set temperature of the storage compartment 217 is not the initial temperature, the set temperature of the storage compartment 217 is changed to the initial temperature. The process illustrated in FIG. 7 is then ended.

In OP103, the package management unit 25 determines whether the remaining time until the start time of the scheduled delivery time slot for the processing target package is equal to or greater than the temperature #2 estimated time and less than the total value of the temperature #1 estimated time and the temperature #2 estimated time. Additionally, in the case where the temperature #3 and so on are set for the processing target package, determination is performed as to whether the remaining time is equal to or greater than a total value of the temperature #2 estimated time and the temperature #3 estimated time and less than a total value of the temperature #1 estimated time to the temperature #3 estimated time. In the case where only the temperature #1 is set, comparison is performed in OP101 between the remaining time and the temperature #1 estimated time. In this case, the process in OP103 is not performed, and in the case where an affirmative determination is made in OP101, the process proceeds to OP104.

In the case where the remaining time until the start time of the scheduled delivery time slot for the processing target package is equal to or greater than the temperature #2 estimated time and less than the total value of the temperature #1 estimated time and the temperature #2 estimated time (OP103: YES), the process proceeds to OP104. In the case where the remaining time until the start time of the scheduled delivery time slot for the processing target package is less than the temperature #2 estimated time (OP103: NO), the process proceeds to OP105.

In OP104, the package management unit 25 determines the set temperature of the storage compartment 217 storing the processing target package to be at the temperature #1. In the case where the set temperature of the storage compartment 217 is not the temperature #1, the set temperature of the storage compartment 217 is changed to the temperature #1. The process illustrated in FIG. 7 is then ended.

In OP105, the package management unit 25 determines the set temperature of the storage compartment 217 storing the processing target package to be at the temperature #2. In the case where the set temperature of the storage compartment 217 is not the temperature #2, the set temperature of the storage compartment 217 is changed to the temperature #2. In the case where the temperature #1 and the temperature #2 are set for the processing target package, the temperature #2 is the same as the hand-over temperature. The process illustrated in FIG. 7 is then ended.

In the process illustrated in FIG. 7, the start time of the scheduled delivery time slot for the processing target package, the initial temperature, the temperature #1, the temperature #1 estimated time, the temperature #2, the temperature #2 estimated time and the like are acquired from the package information management table. Additionally, the temperature control process by the vehicle 2 is not limited to the process illustrated in FIG. 7.

For example, the temperature control process for a package with a package ID “K001” in the package information management table illustrated in FIG. 6 (hereinafter, the package will be referred to as the “package K001”) will be as follows. While the remaining time until the start time of the scheduled delivery time slot is equal to or greater than 8.5 hours that is a total value of the temperature #1 estimated time “8 h” and the temperature #2 estimated time “30 min” (OP101: YES), the package management unit 25 sets the temperature of a storage compartment ID “S001” (hereinafter “storage compartment S001”) to −18 degrees C. that is an initial temperature (OP102). That is, the package K001 is maintained in a frozen state while the remaining time until the start time of the scheduled delivery time slot is 8.5 hours or longer.

Next, when a time passes, and the remaining time until the start time of the scheduled delivery time slot is equal to or greater than the temperature #2 estimated time “30 min” and less than 8.5 hours that is the total value of the temperature #1 estimated time “8 h” and the temperature #2 estimated time “30 min” (OP103: YES), the package management unit 25 sets the temperature of the storage compartment S001 to 5 degrees C., that is, the temperature #1 (OP104). Accordingly, when the remaining time until the start time of the scheduled delivery time slot falls below 8.5 hours, temperature setting for the storage compartment S001 is made 5 degrees C., and defrosting of the package K001 is started. Defrosting of the package K001 is completed before the temperature #1 estimated time passes after the temperature setting for the storage compartment S001 is made 5 degrees C.

Next, when a time passes, and the remaining time until the start time of the scheduled delivery time slot falls below the temperature #2 estimated time “30 min” (OP103: NO), the package management unit 25 sets the temperature of the storage compartment S001 to 15 degrees C., that is, the temperature #2 (OP105). Accordingly, when the remaining time until the start time of the scheduled delivery time slot reaches 30 minutes, the temperature setting for the storage compartment S001 is made 15 degrees C., and the temperature of the package K001 also reaches 15 degrees C. or a temperature close to 15 degrees C. over time. In this example, the package K001 is at a temperature close to a room temperature (15 degrees C.) at the time of handing over of the package K001, and a recipient may immediately eat food in the package K001 after reception.

For example, the temperature control process for a package with a package ID “K003” in the package information management table illustrated in FIG. 6 (hereinafter, the package will be referred to as the “package K003”) will be as follows. In the case where the remaining time until the start time of the scheduled delivery time slot is equal to or greater than the temperature #1 estimated time “5 h” (OP101: YES), the package management unit 25 sets the temperature of a storage compartment ID “S003” (hereinafter “storage compartment S003”) to 15 degrees C. that is the initial temperature (OP102). That is, the package K003 is maintained in a room temperature state (15 degrees C.) while the remaining time until the start time of the scheduled delivery time slot is 5 hours or longer.

Next, when a time passes, and the remaining time until the start time of the scheduled delivery time slot falls below the temperature #1 estimated time “5 h” (OP101: NO), the package management unit 25 sets the temperature of the storage compartment S003 to 65 degrees C., that is, the temperature #1 (OP104). Accordingly, when the remaining time until the start time of the scheduled delivery time slot falls below 5 hours, the temperature setting for the storage compartment S003 is made 65 degrees C., and heating of the package K003 is started. The package K003 may reach 65 degrees C. over the temperature #1 estimated time. In this example, the package K003 is at a temperature close to 65 degrees C. at the time of handing over of the package K003. For example, in the case where the package K003 is a hot-only beverage to be displayed on a shelf in a store (delivery destination), the package K003 may be sold to a customer immediately after being handed over.

### Advantage and Effects of First Embodiment

In the first embodiment, temperature control is performed for the storage compartment 217 storing a package such that the package may be shifted from a first state to a second state during delivery by the vehicle 2. For example, in the case where the package is food in a frozen state, the first state is the frozen state and the second state is a defrosted state, and when a predetermined time before the scheduled delivery time slot is reached, setting is changed such that the temperature of the storage compartment 217 is changed from a temperature for the frozen state to a temperature for a refrigerated state. For example, in the case where the package is a beverage at a room temperature, the first state is a room temperature state and the second state is a state in which the package is heated enough to be sold as a hot beverage, and when a predetermined time before the scheduled delivery time slot is reached, setting is changed such that the temperature of the storage compartment 217 is changed from a temperature for the room temperature state to a temperature for a heating state. According to the first embodiment, food that is a package may be eaten or sold immediately after the package is handed over, and convenience of a recipient receiving the package by delivery may be increased.

### Second Embodiment

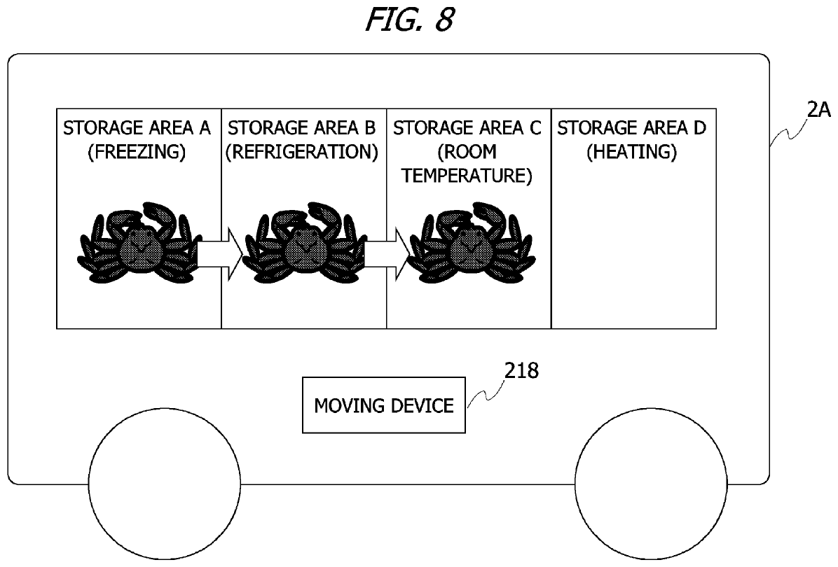

FIG. 8 is a diagram illustrating an example of temperature management for a vehicle 2A according to a second embodiment. In the second embodiment, the vehicle 2A includes, inside itself, a plurality of storage areas with different temperatures, and performs temperature management for a package by moving the package between the storage areas.

In the example illustrated in FIG. 8, four areas of a storage area A at a freezing temperature, a storage area B at a refrigeration temperature, a storage area C at a room temperature, and a storage area D at a heating temperature are provided inside the vehicle 2A. The storage areas are partitioned off by walls or curtains, for example, and are formed as a heater compartment, a refrigerating compartment, a freezer compartment, a room temperature compartment and the like. Movement of a package between the storage areas is performed by a moving device 218. The moving device 218 is a conveyor belt, a robot, a crane including a gripping function, or the like, for example. Additionally, the number of storage areas inside the vehicle 2A, temperature setting for each storage area, and a movement method of a package between the storage areas are not particularly specified.

A hardware configuration of the vehicle 2A is the same as that in the first embodiment except that means forming the storage areas (a wall, a curtain, a heater compartment, a refrigerating compartment, a freezer compartment, a room temperature compartment, etc.) and the moving device 218 for moving a package between the storage areas are included instead of the storage compartment 217. Furthermore, a functional configuration of the vehicle 2A is also the same as that in the first embodiment except that the package management unit 25 controls the moving device 218 instead of controlling the temperature of the storage compartment 217.

A temperature control process by the vehicle 2A is also the same as that in the first embodiment, and is specifically as follows. First, a package is stored in a storage area corresponding to the initial temperature when loaded in the vehicle 2A. Then, the temperature control process illustrated in FIG. 7 is performed for the package. For example, when change of the temperature to the temperature #1 or the temperature #2 is determined in OP104 or OP105 in FIG. 7, the package management unit 25 instructs the moving device 218 to move the target package to the storage area corresponding to the temperature #1 or the temperature #2.

Additionally, a staff member who is to move packages between the storage areas may be deployed in the vehicle 2A, instead of providing the moving device 218. In this case, the package management unit 25 may output an instruction to the staff member to move a package to a predetermined storage area, through a display or a speaker inside the vehicle 2A.

According to the second embodiment, a package that is delivered may be handed over to a recipient after being placed in the state of the hand-over temperature from the state of the initial temperature during delivery by the vehicle 2A.

### OTHER EMBODIMENTS

The embodiment described above is an example, and the present disclosure may be changed and carried out as appropriate without departing from the gist of the present disclosure.

In the first embodiment and the second embodiment, the vehicle 2 or the vehicle 2A performs the temperature control process for the package, but the temperature control process may be alternatively performed by the center server 1. In this case, the center server 1 includes the package information DB 27, performs the temperature control process illustrated in FIG. 7, and instructs the vehicle 2 or the vehicle 2A to change the temperature. The vehicle 2 or the vehicle 2A changes the temperature of the storage compartment 217 or moves the package between the storage areas according to the instruction from the center server 1. In this case, the center server 1 is an example of the “processor”.

In the first and second embodiments, the vehicle 2 and vehicle 2A are assumed to be an autonomous vehicle, but the vehicle 2 and vehicle 2A may be a vehicle that travels by being driven by a person.

The processes and means described in the present disclosure may be freely combined to the extent that no technical conflict exists.

A process which is described to be performed by one device may be performed divided among a plurality of devices. Processes described to be performed by different devices may be performed by one device. Each function is to be implemented by which hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. A delivery system comprising:
a vehicle that includes a storage compartment where a temperature can be changed within a predetermined temperature range, the vehicle being configured to deliver an item stored in the storage compartment to a delivery destination; and
a processor configured to:
acquire a relationship between a current time and a scheduled arrival time of the item at the delivery destination, and
control a temperature of the storage compartment corresponding to the relationship between the current time and the scheduled arrival time of the item at the delivery destination, such that the item reaches a state of a second temperature at a time of handing-over from a state of a first temperature at a time of delivery request.

2. The delivery system according to claim 1, wherein, in a case where a remaining time until the scheduled arrival time at the delivery destination falls below a predetermined threshold, the processor is configured to change the temperature of the storage compartment from the first temperature to the second temperature.

3. A delivery system comprising:
a vehicle that includes a plurality of storage areas with different temperatures and a moving device that moves an item between the storage areas, the vehicle being configured to deliver the item to a delivery destination; and
a processor configured to
acquire a relationship between a current time and a scheduled arrival time of the item at the delivery destination, and
determine a storage area where the item is to be placed, corresponding to the relationship between the current time and the scheduled arrival time of the item at the delivery destination, such that the item reaches a state of a second temperature at a time of handing-over from a state of a first temperature at a time of delivery request.

4. The delivery system according to claim 3, wherein, in a case where a remaining time until the scheduled arrival time at the delivery destination falls below a predetermined threshold, the processor is configured to change the storage area where the item is placed from a first storage area with the first temperature to a second storage area with the second temperature, and instruct the moving device to move the item to the second storage area.

5. A delivery method comprising:
acquiring a relationship between a current time and a scheduled arrival time at a delivery destination of an item that is delivered to the delivery destination by a vehicle including a storage compartment where a temperature can be changed within a predetermined temperature range, wherein the item is delivered being stored in the storage compartment; and
controlling a temperature of the storage compartment according to the relationship between the current time and the scheduled arrival time of the item at the delivery destination, such that the item reaches a state of a second temperature at a time of handing-over from a state of a first temperature at a time of delivery request.
